(19) United States
(12) Patent Application Publication
(10) Pub. No.: US 2023/0271197 A1
(43) Pub. Date: Aug. 31, 2023

(54) CENTRIFUGE INSERTS

(71) Applicant: Cambium Analytica, Traverse City, MI (US)

(72) Inventor: Michael Leasia, Traverse City, MI (US)

(21) Appl. No.: 18/175,820

(22) Filed: Feb. 28, 2023

Related U.S. Application Data
(60) Provisional application No. 63/314,668, filed on Feb. 28, 2022.

(51) Int. Cl. B04B 5/04; B01L 3/00; B01L 9/06

(52) U.S. Cl. CPC B04B 5/0407; B01L 3/5021; B01L 9/06; B01L 2200/025

(57) ABSTRACT

The present disclosure provides an insert for supporting a specimen within a centrifuge. The insert includes at least a base having a central aperture for receiving a receptacle and a specimen support. The specimen support is selectively coupled to the base and includes at least one aperture extending through the specimen support and in fluid communication with the receptacle.

### RELATED APPLICATION

The present application claims priority to U.S. Provisional Patent Application No. 63/614,668, filed Feb. 28, 2022, the entire contents of which are incorporated herein by reference.

### FIELD

The present disclosure relates to centrifuges, and more particularly to inserts for supporting a specimen within a centrifuge.

### SUMMARY

A centrifuge is a machine which rapidly rotates a container thereby applying a centrifugal force to contents of the container. A centrifuge can contain inserts for supporting containers of various sizes and shapes during rotation.

A standard centrifuge insert is designed to support a container during operation of the centrifuge. With such an insert, the contents of the container must remain within the container, because the inserts do not provide a mechanism for collecting the contents if removed from the container. However, in some instances it is desirable to use a centrifuge to remove the contents from the container. A different centrifuge insert is therefore needed which provides a pathway between the supported container and a content collection apparatus.

Thus, the present disclosure provides, in one aspect, a centrifuge insert including a base and a specimen support. The base includes a central aperture configured to receive a receptacle. The specimen support is configured to be selectively coupled to the base. At least one aperture extends through the specimen support and is in fluid communication with the receptacle.

The present disclosure provides, in another aspect, a fluid collection apparatus including a cartridge support and a fluid repository. The cartridge support includes a through bore configured to receive a cartridge containing a fluid. The fluid repository is configured to be selectively coupled to the cartridge support and is in fluid communication with the cartridge when the fluid repository is coupled to the cartridge support.

The present disclosure provides, in yet another aspect, a fluid collection apparatus including an insert base configured to be received within a centrifuge cup of a centrifuge and an insert top configured to support a fluid containing specimen in fluid communication with the insert base.

Other features and aspects of the disclosure will become apparent by consideration of the following detailed description and accompanying drawings.

### BRIEF DESCRIPTION OF THE DRAWINGS

FIG. 1 is a perspective view of a centrifuge according to some embodiments.

FIG. 2 is a perspective view of a cartridge according to some embodiments.

FIG. 3 is a perspective view of a centrifuge insert according to one embodiment of the present disclosure.

FIG. 4 is an exploded perspective view of the centrifuge insert of FIG. 3 according to some embodiments.

FIG. 5 is a perspective view of a base of the centrifuge insert of FIG. 3 according to some embodiments.

FIG. 6 is a perspective view of a specimen support according to one embodiment of the present disclosure.

FIG. 7 is a cross-sectional view of the specimen support of FIG. 6, taken along section line 7-7 in FIG. 6 according to some embodiments.

FIG. 8 is a perspective view of a specimen support according to another embodiment of the present disclosure.

FIG. 9 is a cross-sectional view of the specimen support of FIG. 8, taken along section line 9-9 in FIG. 8 according to some embodiments.

FIG. 10 is a perspective view of a specimen support according to another embodiment of the present disclosure.

FIG. 11 is a cross-sectional view of the specimen support of FIG. 10, taken along section line 11-11 in FIG. 10 according to some embodiments.

FIG. 12 is a perspective view of a specimen support according to another embodiment of the present disclosure.

FIG. 13 is a cross-sectional view of the specimen support of FIG. 12, taken along section line 13-13 in FIG. 12 according to some embodiments.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

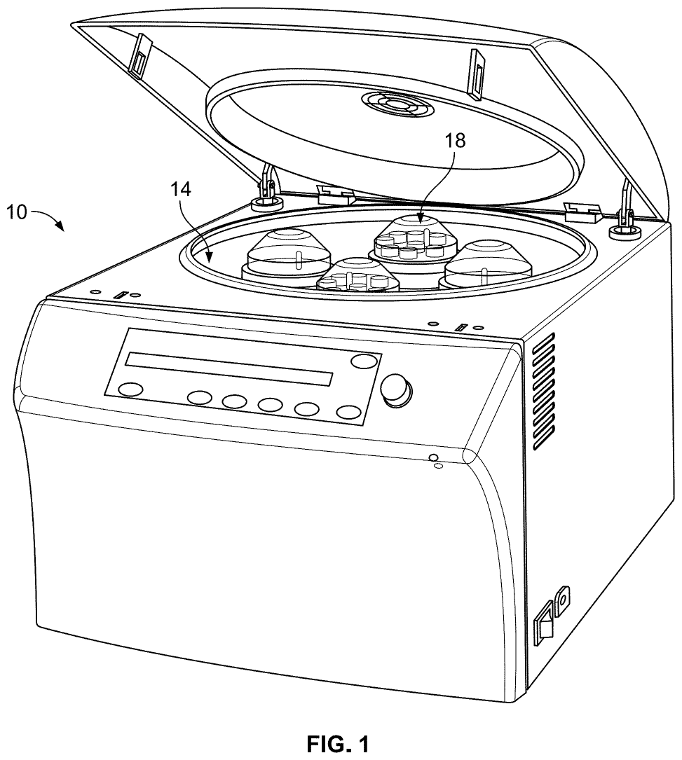

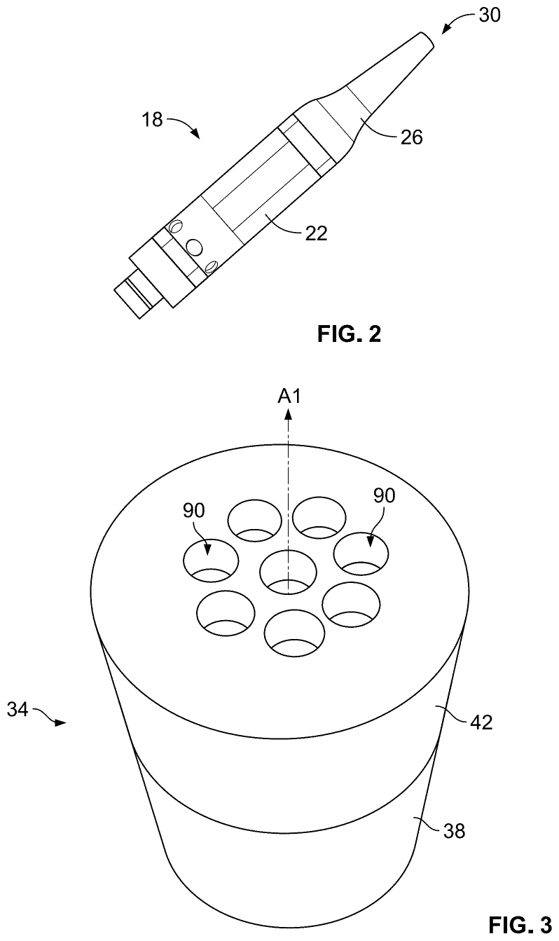

FIG. 1 illustrates an example of a typical centrifuge 10. The centrifuge 10 contains an operating region 14 which supports various specimen 18 to be rapidly rotated about a central axis, thereby applying a centrifugal force to the specimen 18. In the illustrated embodiment, a plurality of specimen 18 is supported in groups spaced circumferentially around the operating region 14. An example of a specimen 18, illustrated as a cartridge containing a fluid, such as but not limited to an oil (e.g., CBD oil, Hemp oil, Nicotine, etc.), is depicted in FIG. 2. Such cartridges 18 may have varying sizes and shapes, as will be understood by one of ordinary skill in the art. In particular, the cartridge 18 depicted in FIG. 2 has a substantially cylindrical body 22 which stores oil. Coupled to one side of the body 22 is a tip 26 containing an opening 30 which allows the oil to be drawn from the cartridge 18. The cartridge 18 may contain fluids other than oil, which may be more or less viscous than oil. For example, in some embodiments, the cartridge 18 may contain a non-oil based liquid (e.g., water or water-based liquid) or a combination of liquids and/or fluids. Application of centrifugal force to the cartridge 18 by the centrifuge 10 draws the contents (e.g., the oil) of the cartridge 18 out of the body 22. It is advantageous to be able to draw out and collect oil from cartridges 18 to facilitate testing of the oil. However, typical centrifuge inserts do not provide a fluid pathway for collecting oil after it is drawn out from the cartridge 18. As is described in greater detail below, the present disclosure provides an insert 34 for use with the centrifuge 10 to support the cartridge 18 and collect the contents of the cartridge 18 that are drawn out due to operation of the centrifuge 10.

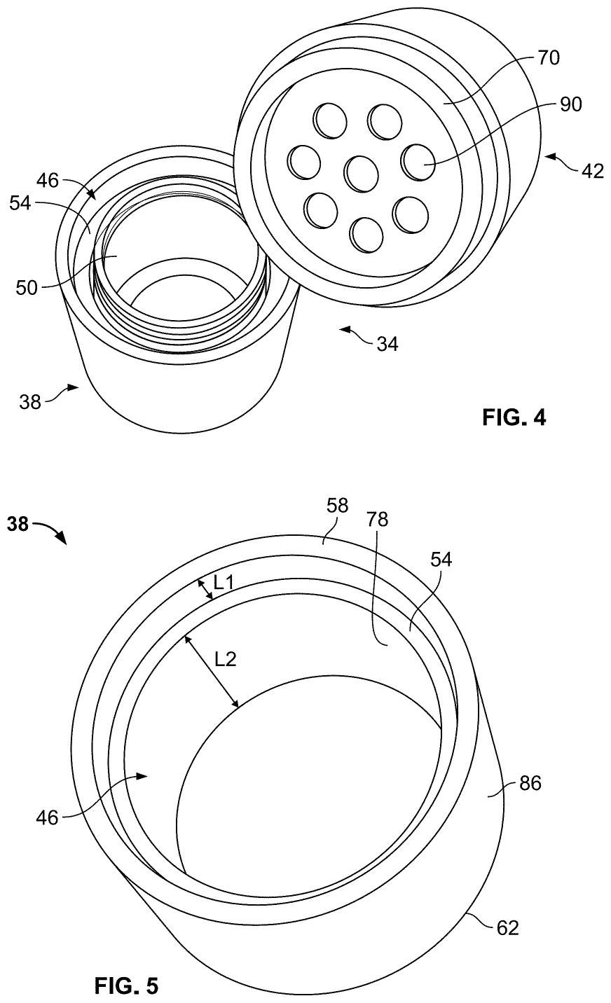

FIGS. 3-7 illustrate one embodiment of a centrifuge insert 34. The insert 34 is shaped to be received within the centrifuge 10 (e.g., within a centrifuge cup of the centrifuge 10) and support at least one specimen, illustrated as a cartridge 18 (See FIG. 2), during operation of the centrifuge 10. In the illustrated embodiment, the insert 34 can support a plurality of cartridges 18. Each insert 34 includes at least a base 38 and an insert top, or specimen support, 42 for supporting the at least one cartridge 18 within the insert 34. With reference to FIGS. 3-5, the base 38 includes a central aperture 46 extending along a longitudinal axis Al of the insert 34. The central aperture 46 of the illustrated embodiment extends through the entirety of the base 38. In other words, the central aperture 46 forms a through bore in the base 38. However, in other embodiments, the central aperture 46 may form a blind bore extending only part of the way through the base 38. The central aperture 46 of the illustrated base 38 receives a fluid receptacle 50 or repository, illustrated as a jar in FIG. 4, to collect contents that are drawn out of the cartridge 18 during operation of the centrifuge 10. In some embodiments, such as when the central aperture 46 extends only part way through the base 38, no jar (e.g., fluid receptacle 50) is necessary to collect the contents drawn from the cartridge 18, and the central aperture 46 forms the fluid repository.

The base 38 further includes a step 54 proximate one side of the central aperture 46. The step 54 cooperates with the insert top 42 to secure the insert base 38 to the insert top 42 during operation. The step 54 is formed due to a portion of the central aperture 46 increasing in cross-sectional area relative to the remainder of the central aperture 46, as viewed along the longitudinal axis Al of the insert 34 and assists in coupling of the base 38 to the insert top 42. As measured along the longitudinal axis A1 (and illustrated in the embodiment), the step 54 is shorter than the remainder of the central aperture 46. In other words, the step 54 is located a distance L1 from a first longitudinal side 58 of the base 38 and a distance L2 from a second longitudinal side 62 of the base 38. The distance L2 is greater than the distance L1, and the insert top 42 is coupled to the side 58 from which distance L1 is measured. However, in other embodiments, the distance L2 is shorter than the distance L1. In some embodiments, the step 54 is formed as a change in the cross-sectional shape of the central aperture 46 (e.g., elliptical to polygonal) rather than as a change in the cross-sectional area of the central aperture 46 as illustrated.

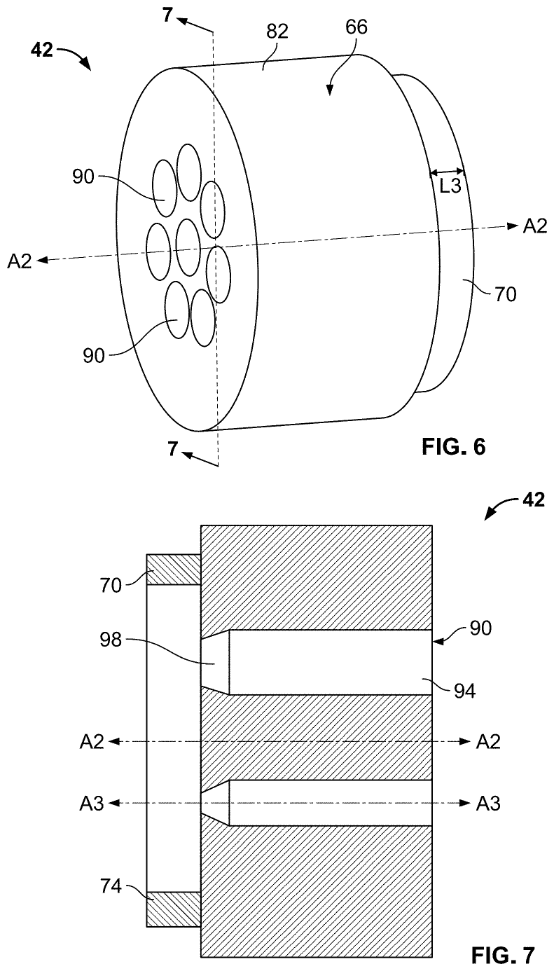

FIGS. 6 and 7 illustrate an insert top 42 according to one embodiment of the present disclosure. As previously stated, the insert top 42 supports at least one cartridge 18 within the insert 34 and, in particular, supports the at least one cartridge 18 relative to the fluid repository 50 in the base 38. The insert top 42 includes a body 66 from which an axial protrusion 70 extends in a direction parallel to the longitudinal axis Al of the insert 34. The axial protrusion 70 is sized to engage the step 54 when the insert top 42 is coupled to the insert base 38. The axial protrusion 70 is similar in shape to a perimeter of the insert top 42 and is offset inwards (e.g., towards a centrally located longitudinal axis A2 of the insert top 42) to align with the step 54. As best shown in FIG. 4, a cross-sectional shape of the axial protrusion 70, as viewed along the longitudinal axis A2 of the insert top 42, corresponds to a shape of the step 54 so that, when the insert top 42 is coupled to the insert base 38, an inner surface 74 of the axial protrusion 70 is flush with an inner surface 78 of the central aperture 46. Furthermore, a length L3 of the axial protrusion 70 is equal to the length L1 between the step 54 and the first side 58 of the insert base 38 so that, when coupled, the body 66 of the insert top 42 abuts the insert base 38. The insert top 42 and the insert base 38 of the illustrated embodiment are both cylindrical, and the outer surfaces 82, 86 of the insert top 42 and the insert base 38, respectively, are flush when the insert top 42 and the insert base 38 are coupled together. However, one of ordinary skill in the art will understand that the insert 34 may take the form of any other three-dimensional shape having a longitudinal axis (e.g., the insert 34 may be rectangular). Furthermore, the insert base 38 and the insert top 42 need not be the same shape as long as the axial protrusion 70 is capable of engaging the step 54.

The insert top 42 further includes at least one aperture 90 extending through the body 66 and oriented parallel to the longitudinal axis A2. The aperture 90 is sized and shaped to receive the cartridge 18 and extends through an entirety of the insert top 42. When the insert top 42 is coupled to the insert base 38, the aperture 90 creates an uninterrupted fluid pathway between the fluid repository 50 of the base 38 and the cartridge 18. The axial protrusion 70 forms a perimeter about the aperture 90 to ensure that the aperture 90 is aligned with the central aperture 46 of the base 38. As best illustrated in FIG. 7, the aperture 90 includes a first portion 94 of constant cross-section and a second portion 98 of a varying cross-section. The first portion 94 receives the cartridge body 22, while the second portion 98 receives the cartridge tip 26 and prevents the cartridge 18 from moving through the aperture 90. In the illustrated embodiment, the first portion 94 is longer than the second portion 98. The second portion 98 is located proximate the axial protrusion 70 and the insert base 38 when the insert top 42 is coupled to the insert base 38. Thus, the opening 30 of the tip 26 is facing the fluid repository 50. In the illustrated embodiment, the varying cross-section of the second portion 98 is formed as a constant taper towards a longitudinal axis A3 of the aperture 90. The constant taper decreases the cross-sectional area of the second portion 98 relative to the first portion 94 to prevent the cartridge 18 from moving through the aperture 90. In other embodiments, the second portion 98 may be formed as a step or discrete change in the cross-sectional area of the aperture 90 rather than a taper. The aperture 90 of the illustrated embodiment is circular in cross-section, as viewed along its longitudinal axis A3, so as to receive the cylindrical shaped body 22 of the cartridge 18 (See FIG. 2). In other embodiments the cross-sectional shape of the aperture 90 may be different to correspond to different shape cartridges, as is described in greater detail later. Similarly, the cross-sectional shapes of the first and second portions 94, 98 need not be the same shape. For example, the first portion 94 may have an elliptical cross-section corresponding to a similarly shaped cartridge body 22, and the second portion 98 may have a rectangular cross-section corresponding to a similarly shaped cartridge tip 26. With regards to the orientation of the aperture 90 within the insert top 42, as best illustrated in FIG. 7, the longitudinal axis A3 of the aperture 90 is parallel to the longitudinal axis A2 of the insert top 42. However, one of ordinary skill in the art will understand that the aperture 90 need not be oriented parallel to the longitudinal axis A2 in order to properly function. Rather, the aperture 90 need only be oriented to support the cartridge 18 in fluid communication with the fluid repository 50 and in a direction that allows the contents of the cartridge 18 to flow out of the tip 26 due to centrifugal force applied by operation of the centrifuge 10.

In use, the above-described centrifuge insert 34 supports at least one cartridge 18 within a centrifuge 10 such that operation of the centrifuge 10 draws fluid out of the cartridge 18, and the fluid is collected within the fluid receptacle 50. The insert base 38 is first placed within the centrifuge 10. Optionally, the fluid receptacle 50 is then placed within the central aperture 46 of the insert base 38. Next, the insert top 42 is coupled to the insert base 38 such that the axial protrusion 70 engages the step 54, and the body 66 of the insert top 42 abuts against the insert base 38. One or more cartridges 18 are then inserted into one or more apertures 90 of the insert top 42. The cartridge 18 is oriented such that the tip 26 is proximate the second portion 98 of the aperture 90 and the fluid receptacle 50. At this point, an uninterrupted fluid pathway is formed between the cartridge 18 and the fluid receptacle 50, while the cartridge 18 and the fluid receptacle 50 are supported by the insert 34 to prevent relative movement between the two 18, 50 during operation of the centrifuge 10. As the centrifuge 10 spins, centrifugal force draws fluid from the cartridge 18, and the fluid is collected in the receptacle 50. Furthermore, as the centrifuge 10 spins, the step 54 of the inert base 38 and the axial protrusion 70 of the insert top 42 cooperate to resist the forces applied by the centrifuge 10, thereby maintaining alignment of the insert base 38 and the insert top 42 so that the aperture 90 maintains direct fluid communication with the insert base 38.

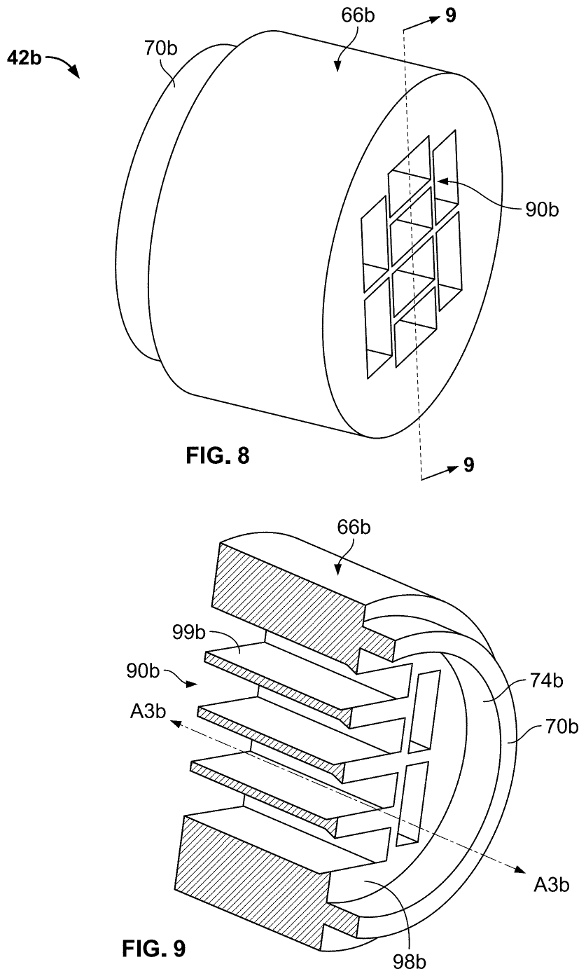

FIGS. 8 and 9 illustrate another embodiment of an insert top 42b according to the present disclosure, with like parts having like reference numerals plus the letter “b” and the following differences explained below. The cartridge receiving aperture 90b is rectangular in cross-section, as viewed along the longitudinal axis A3b of the aperture 90b to correspond to a rectangular cartridge (not shown).

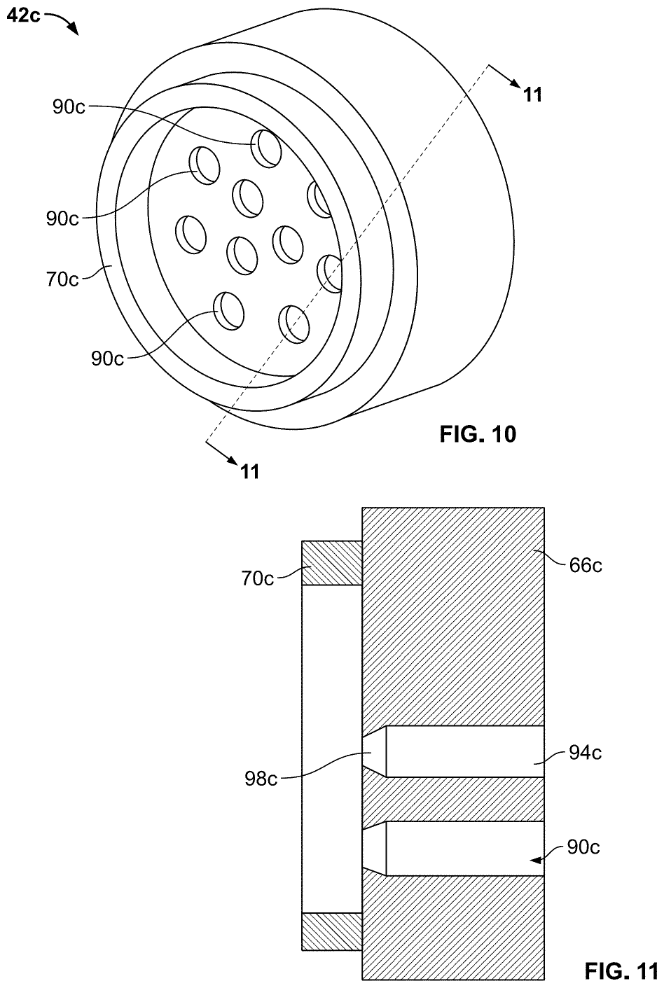

FIGS. 10 and 11 illustrate yet another embodiment of an insert top 42c, with like parts having like reference numerals plus the letter “c” and the following differences explained below. The cross-sectional shape of the aperture 90c is similar in shape to those of FIGS. 6 and 7, however, the area is smaller.

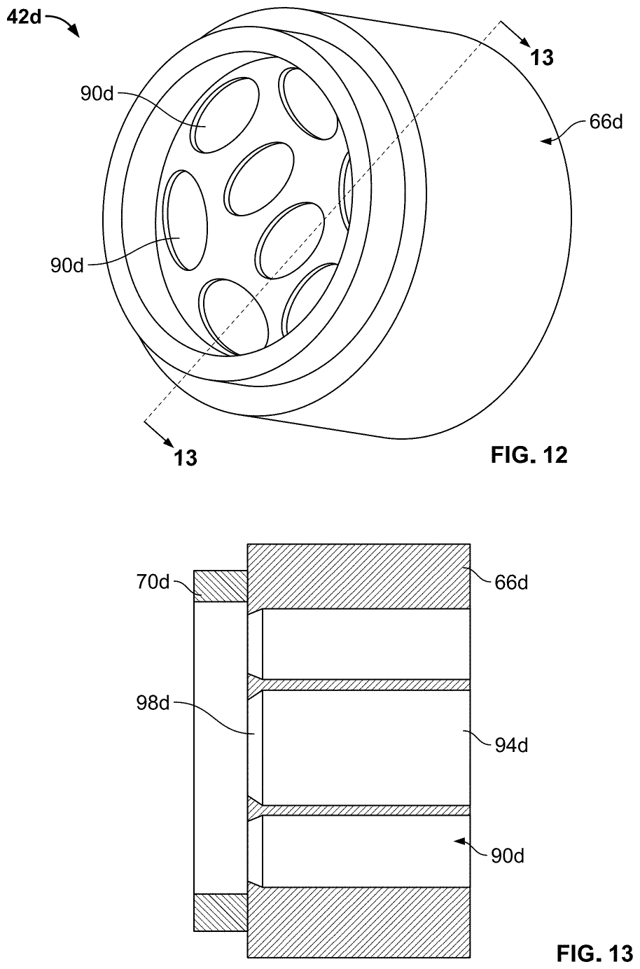

FIGS. 12 and 13 illustrate yet another embodiment of an insert top 42d, with like parts having like reference numerals plus the letter “d” and the following differences explained below. Rather than the cartridge receiving aperture 90d having a circular cross-sectional shape, the aperture 90c is elliptical.

One of ordinary skill in the art will understand that any two-dimensional shape, in particular any elliptical or polygonal shapes, may be used as the cross-sectional shape of the apertures 90 so long as the shape corresponds to a cross-sectional shape of a cartridge 18. Similarly, a single insert top 42 may include only similarly shaped apertures 90, or the insert top 42 may include a plurality of apertures 90 of various shapes.

The above-described centrifuge inserts provide the advantage of supporting a plurality of cartridges within a centrifuge. Each cartridge is in fluid communication with a receptacle that collects fluid drawn from the cartridge during operation of the centrifuge, thereby efficiently collecting the fluid for testing.

Various features of the disclosure are set forth in the following claims.

What is claimed is:

1. An insert for a centrifuge, the insert comprising:
a base having a central aperture configured to receive a receptacle; and
a specimen support configured to be selectively coupled to the base and having at least one aperture extending through the specimen support and in fluid communication with the receptacle.

2. The insert of claim 1, wherein the base includes a top portion and a bottom portion, wherein a cross-sectional area of the central aperture as viewed along a longitudinal axis of the insert increases proximate the top portion, and wherein the change in cross-sectional area forms a step.

3. The insert of claim 2, wherein the specimen support includes an axial protrusion configured to engage the step when the specimen support is coupled to the base.

4. The insert of claim 1, wherein the at least one aperture includes a first portion having a first cross-sectional area as viewed along a longitudinal axis of the insert and a second portion having a second cross-sectional area as viewed along the longitudinal axis of the insert.

5. The insert of claim 4, wherein the cross-sectional area of the second portion is smaller than the cross-sectional area of the first portion.

6. The insert of claim 5, wherein the second portion is closer to an axial protrusion than the first portion, wherein the axial protrusion is configured to engage a step when the specimen support is coupled to the base.

7. The insert of claim 5, wherein the second portion tapers toward a longitudinal axis of the aperture.

8. The insert of claim 4, wherein the first cross-sectional area is at least one selected from a group consisting of elliptical, and polygonal shapes.

9. The insert of claim 8, wherein the specimen support includes a plurality of apertures, each aperture having a similar cross-sectional shape.

10. A fluid collection apparatus comprising:
a cartridge support including a through bore configured to receive a cartridge containing a fluid; and
a fluid repository configured to be selectively coupled to the cartridge support;
wherein the fluid repository is in fluid communication with the cartridge when the fluid repository is coupled to the cartridge support.

11. The fluid collection apparatus of claim 10, wherein the through bore includes a straight portion and a tapered portion, and wherein the tapered portion is proximate the fluid repository when the cartridge support is coupled to the fluid repository.

12. The fluid collection apparatus of claim 10, wherein the cartridge support includes a body through which the through bore extends and a securement protrusion extending from an axial face of the body in a direction parallel to a central axis of the through bore.

13. The fluid collection apparatus of claim 12, wherein the securement protrusion forms a perimeter about the through bore when viewed along the central axis of the through bore.

14. The fluid collection apparatus of claim 13, wherein the securement protrusion is disposed within a perimeter of the body when viewed along the central axis of the through bore.

15. The fluid collection apparatus of claim 14, wherein the fluid repository includes a central opening, wherein the securement protrusion is configured to be received within the central opening, and wherein the axial face of the body abuts against the fluid repository when the cartridge support is coupled to the fluid repository.

16. The fluid collection apparatus of claim 10, wherein the fluid collection apparatus is configured to be received by a centrifuge.

17. The fluid collection apparatus of claim 16, wherein the fluid contained in the cartridge flows from the cartridge to be collected in the fluid repository when the centrifuge is operational.

18. A fluid collection apparatus comprising:
an insert base configured to be received within a centrifuge cup of a centrifuge; and
an insert top configured to support a fluid containing specimen in fluid communication with the insert base.

19. The fluid collection apparatus of claim 18, wherein the insert top includes at least one aperture configured to receive the fluid containing specimen therein.

20. The fluid collection apparatus of claim 19, wherein the at least one aperture is in direct fluid communication with the insert base.

21. The fluid collection apparatus of claim 19, wherein the at least one aperture is at least one selected from a group consisting of a circular shape, an elliptical shape, and a polygonal shape.

22. The fluid collection apparatus of claim 21, wherein a portion of the at least one aperture that is proximate the insert base has a smaller radius than a distal portion of the at least one aperture.

23. The fluid collection apparatus of claim 18, further comprising a fluid receptacle removably received within the insert base, the fluid receptacle configured to collect fluid from the fluid specimen.
